(19) United States
(12) Patent Application Publication
(10) Pub. No.: US 2020/0045452 A1
(43) Pub. Date: Feb. 6, 2020

(54) VOICE COIL AND SPEAKER

(71) Applicant: AAC ACOUSTIC TECHNOLOGIES (SHENZHEN) CO., LTD., Shenzhen (CN)

(72) Inventors: Kejia Liu, Shenzhen (CN); Yao Hui, Shenzhen (CN); Dong Lu, Shenzhen (CN); Weimin Chen, Shenzhen (CN)

(21) Appl. No.: 16/524,178

(22) Filed: Jul. 29, 2019

(30) Foreign Application Priority Data
Aug. 1, 2018 (CN) 201821235841.0

(51) Int. Cl. H04R 9/04; H04R 1/06; H04R 9/06

(52) U.S. Cl. CPC H04R 9/046; H04R 9/06; H04R 1/06

(57) ABSTRACT

Embodiments of the present disclosure relate to audio devices, especially to a voice coil and a speaker. The voice coil includes a voice-coil winding and a lead structure led out from the voice-coil winding. The lead structure includes a first starting terminal, a second starting terminal, a first lead and a second lead. Both the first starting terminal and the second starting terminal are located on the voice-coil winding. The first lead is formed by extending from the first starting terminal, and the second lead is formed by extending from the second starting terminal. The first lead and the second lead are centrally symmetrical about a geometric center of the voice-coil winding. The voice coil and the speaker in the embodiments of the present disclosure have an advantage of weakening swinging of a speaker during operation.

### TECHNICAL FIELD

Embodiments of the present disclosure relate to audio devices, especially to a voice coil and a speaker.

### BACKGROUND

In recent years, with a development of technology, especially a rapid development of mobile communication technology, more and more mobile electronic devices appear in people's daily lives, for example, smart phones, tablets, laptops and multi-media players have become daily necessities in people's lives. In such a mobile electronic device, a voice playing apparatus is an indispensable component, and voice quality directly affects user experience when a user uses the mobile electronic device.

A structure design of a speaker as a voice playing apparatus in existing technologies directly affects quality of voice playing. A main operation principle of an existing speaker is to drive a diaphragm to vibrate and emit sound through a movement of a voice coil.

However, the inventor of the present disclosure found that in the existing technologies, a speaker mainly supplies power to the voice coil through a lead. A led-out manner of the lead in the existing technologies can cause unbalanced stiffness of the speaker, resulting in the speaker's swinging during operation. The swinging is even worse when a smart power amplifier is introduced.

### BRIEF DESCRIPTION OF THE DRAWINGS

FIG. 1 is a schematic structural view of a voice coil in a first embodiment of the present disclosure;

FIG. 2 is a schematic structural view of a voice coil in another embodiment of the present disclosure.

### DETAILED DESCRIPTION

In order to make objectives, technical solutions and advantages of embodiments of the present disclosure clearer, the embodiments of the present disclosure will be described in detail below with reference to accompanying drawings. However, it should be understood by those skilled in the art that, in the embodiments of the present disclosure, many technical details are described in order to provide a better understanding of the present disclosure. However, the technical solutions claimed in the present disclosure may be realized without these technical details and changes and modifications based on the following embodiments.

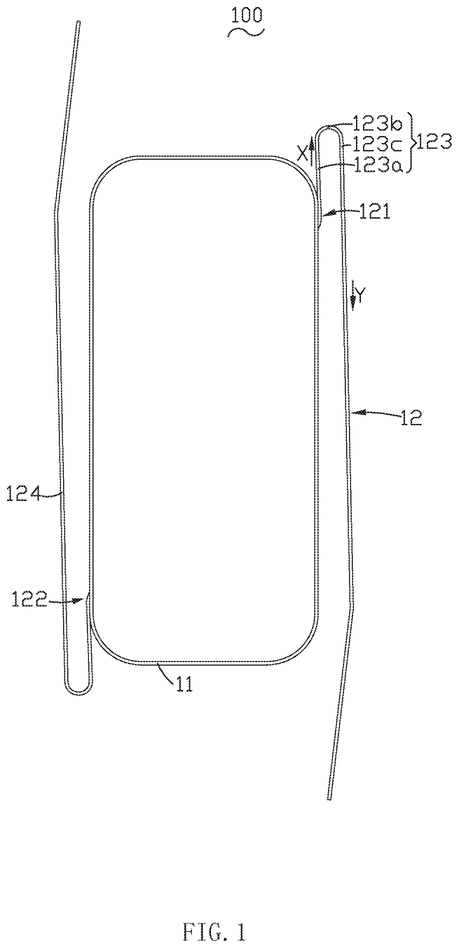

A first embodiment of the present disclosure relates to a voice coil 100. As shown in FIG. 1, the voice coil 100 includes a voice-coil winding 11, and a lead structure 12 led out from the voice-coil winding. The lead structure 12 includes a first starting terminal 121, a second starting terminal 122, a first lead 123, and a second lead 124. The first starting terminal 121 and the second starting terminal 122 are located on the voice-coil winding 11. The first lead 123 is formed by extending from the first starting terminal 121 and the second lead 124 is formed by extending from the second starting terminal 122. The first lead 123 and the second lead 124 are centrally symmetrical about a geometric center of the voice-coil winding 11.

Compared with existing technologies, the voice coil 100 in the first embodiment of the present disclosure makes the first lead 123 and the second lead 124 centrally symmetrical about a geometric center of the voice-coil winding 11, so that reactions of the two leads are symmetrical. Therefore, stiffness of the speaker in respective directions is the same, thereby weakening swinging caused by unbalanced stiffness during operation.

Preferably, in the present embodiment, the first lead 123 includes a connecting portion 123a connected to the first starting terminal 121 and formed by extending from the first starting terminal 121 in a first direction (the X direction as shown in FIG. 1), a bent portion 123b bent from an end of the connecting portion 123a away from the first starting terminal 121, and an extended portion 123c extending from an end of the bent portion 123b away from the connecting portion 123a in a second direction (the Y direction as shown in FIG. 1). The first direction is distinguishing from the second direction. Disposed in a bending manner, the first lead 123 which consists of three portions can reduce stiffness and ensure reliability thereof.

Further, in this embodiment, the voice-coil winding 11 is a rectangular structure, and the first starting terminal 121 and the second starting terminal 122 are disposed on two straight sides of the rectangular structure which are opposite to each other. That the first starting terminal 121 and the second starting terminal 122 are both disposed on straight sides can effectively reduce effect of the lead structure on resonance frequency of the voice coil 100, and improve tone quality of the voice coil.

More preferably, in the present embodiment, the first starting terminal 121 and the second starting terminal 122 are respectively disposed in the middle of the corresponding straight side. In this way, vibration displacement under the same phase angle may be reduced, thereby further weakening swinging.

Specifically, in this embodiment, the first direction is parallel to the straight sides and the first direction is opposite to the second direction.

More specifically, in this embodiment, the bent portion 123b is in an arc shape.

Further, an end of the extended portion 123c away from the bent portion 123b is bent towards the voice-coil winding 11.

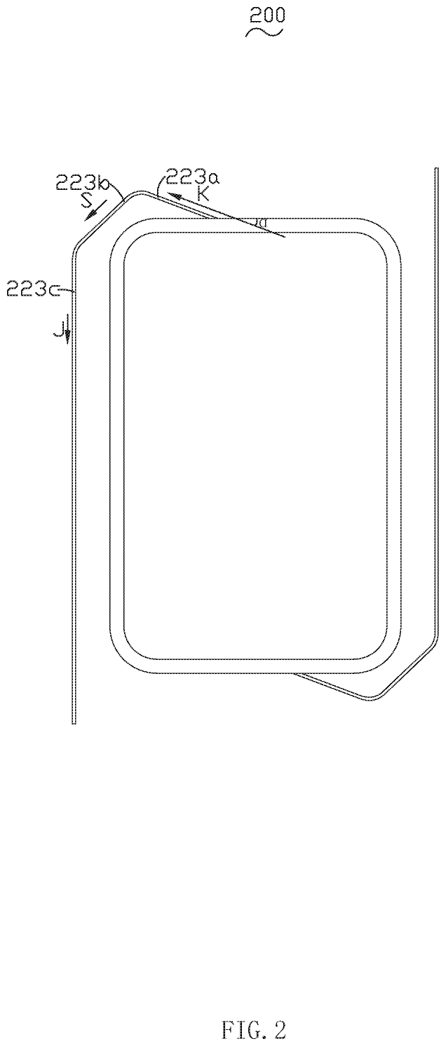

Further, as shown in FIG. 2, with respect to the voice coil 200 in another embodiment of the present disclosure, an angle (the angle α as shown in FIG. 2) between the first direction (the direction K as shown in FIG. 2) and the straight sides is an acute angle, and the second direction (the direction J as shown in FIG. 2) is parallel to the straight sides.

Further, the bent portion 223b extends from the connecting portion 223a to the extended portion 223c in a third direction (the direction S as shown in FIG. 2), and the third direction is distinguishing from both the first direction and the second direction.

It should be understood that due to an error in a practical process, being “centrally symmetrical” and being “parallel” involved in the embodiments of the present disclosure further include being approximately centrally symmetrical and being approximately parallel that may achieve an effect of the present disclosure.

A second embodiment of the present disclosure relates to a speaker which includes a voice coil 100 in the first embodiment of the present disclosure and a voice coil 200 in the second embodiment of the present disclosure.

Those skilled in the art may understand that the above-described embodiments are specific examples that can realize the present disclosure. In practice, however, changes may be made to the embodiments in terms of forms and details without departing from the spirit and scope of the present disclosure.

What is claimed is:

1. A voice coil, comprising a voice-coil winding and a lead structure led out from the voice-coil winding, wherein the lead structure comprises a first starting terminal, a second starting terminal, a first lead and a second lead, wherein both the first starting terminal and the second starting terminal are located on the voice-coil winding, the first lead is formed by extending from the first starting terminal, and the second lead is formed by extending from the second starting terminal, wherein the first lead and the second lead are centrally symmetrical about a geometric center of the voice-coil winding.

2. The voice coil according to claim 1, wherein the first lead comprises a connecting portion connected to the first starting terminal and extending from the first starting terminal in a first direction, a bent portion bent from an end of the connecting portion away from the first starting terminal, and an extended portion extending from an end of the bent portion away from the connecting portion in a second direction, and the first direction is distinguishing from the second direction.

3. The voice coil according to claim 2, wherein the voice-coil winding is a rectangular structure, and the first starting terminal and the second starting terminal are disposed on two straight sides of the rectangular structure which are opposite to each other.

4. The voice coil according to claim 3, wherein the first direction is parallel to the straight sides, and the second direction is opposite to the first direction.

5. The voice coil according to claim 4, wherein the bent portion is in an arc shape.

6. The voice coil according to claim 4, wherein an end of the extended portion away from the bent portion is bent towards the voice-coil winding.

7. The voice coil according to claim 3, wherein an angle between the first direction and the straight sides is an acute angle, and the second direction is parallel to the straight sides.

8. The voice coil according to claim 2, wherein the bent portion extends from the connecting portion to the extended portion in a third direction, and the third direction is distinguishing from both the first direction and the second direction.

9. A speaker comprising a voice coil, wherein the voice coil comprises a voice-coil winding and a lead structure led out from the voice-coil winding, wherein the lead structure comprises a first starting terminal, a second starting terminal, a first lead and a second lead, wherein both the first starting terminal and the second starting terminal are located on the voice-coil winding, the first lead is formed by extending from the first starting terminal, and the second lead is formed by extending from the second starting terminal, wherein the first lead and the second lead are centrally symmetrical about a geometric center of the voice-coil winding.

10. The speaker according to claim 9, wherein the first lead comprises a connecting portion connected to the first starting terminal and extending from the first starting terminal in a first direction, a bent portion bent from an end of the connecting portion away from the first starting terminal, and an extended portion extending from an end of the bent portion away from the connecting portion in a second direction, and the first direction is distinguishing from the second direction.

11. The speaker according to claim 10, wherein the voice-coil winding is a rectangular structure, and the first starting terminal and the second starting terminal are disposed on two straight sides of the rectangular structure which are opposite to each other.

12. The speaker according to claim 11, wherein the first direction is parallel to the straight sides, and the second direction is opposite to the first direction.

13. The speaker according to claim 12, wherein the bent portion is in an arc shape.

14. The speaker according to claim 12, wherein an end of the extended portion away from the bent portion is bent towards the voice-coil winding.

15. The speaker according to claim 11, wherein an angle between the first direction and the straight sides is an acute angle, and the second direction is parallel to the straight sides.

16. The speaker according to claim 10, wherein the bent portion extends from the connecting portion to the extended portion in a third direction, and the third direction is distinguishing from both the first direction and the second direction.
